(19) United States
(12) Patent Application Publication
(10) Pub. No.: US 2016/0247596 A1
(43) Pub. Date: Aug. 25, 2016

(54) COMPOSITE HIGH VOLTAGE INSULTATION MATERIALS AND METHODS FOR PREPARING THE SAME

(71) Applicant: ABB Research Ltd., Zurich (CH)

(72) Inventors: Chau-Hon Ho, Lorrach (DE); Spiros Tzavalas, Lengnau (CH); Cherif Ghoul, Mulhouse (FR); Göran Paulsson, Zurich (CH)

(21) Appl. No.: 15/142,924

(22) Filed: Apr. 29, 2016

Related U.S. Application Data
(63) Continuation of application No. PCT/EP2013/072839, filed on Oct. 31, 2013.

(51) Int. Cl. H01B 3/40; C08L 63/00; C08G 59/06; H02K 3/30

(52) U.S. Cl. CPC H01B 3/40; H02K 3/30; C08L 63/00; C08G 59/063

(57) ABSTRACT

The present invention relates to an anhydride-free curable epoxy resin composition for use as high voltage (HV) insulation, to an anhydride-free curable epoxy resin mica composite or an anhydride-free curable epoxy resin cellulose composite comprising the same, to an insulating material obtained by curing the anhydride-free curable epoxy resin composition, the anhydride-free curable epoxy resin mica composite or the anhydride-free curable epoxy resin cellulose composite as well as to a process for producing the same.

### FIELD OF INVENTION

The present invention relates to an anhydride-free curable epoxy resin composition for use a high voltage (HV) insulation, in particular as HV insulation for main wall insulation, specifically in form of wound insulations for HV motors. Further, the present invention refers to an anhydride-free curable epoxy resin mica composite comprising the anhydride-free curable epoxy resin composition and a mica compound. Moreover, the present invention is also directed to an insulating material obtained by curing the anhydride-free curable epoxy resin composition or the anhydride-free curable epoxy resin mica composite. Additionally, the present invention is directed to a process for producing the anhydride-free curable epoxy resin composition, a process for producing the anhydride-free curable epoxy resin mica composite as well as to a process for producing the insulating material. Also, the present invention is concerned with an electrical machine coil comprising an insulation layer of the insulating material, and with an electrical article comprising said electrical machine coil.

### STATE OF THE ART

In the production of electrical insulations, in particular in the production of HV applications, such as HV motors, epoxy-anhydride systems are widely used as thermoset resins due to their superior electrical insulation performance. In this regard, in HV motors, a voltage above 1 kV is generally understood to be high voltage (HV). Moreover, a voltage below 1 kV is generally understood to be low voltage (LV). In particular, epoxy-anhydride systems exhibit excellent dielectric properties which are usually not obtained for pure epoxy systems.

However, epoxy-anhydride systems exhibit increased dielectric losses after 1 year storage under ambient conditions (even higher losses measured at >160° C.) due to their relatively high polarity. More specifically, anhydrides have a polar character and lead to rather polar epoxy-anhydride networks with polar and hydrolysable ester groups. After reaction with water (moisture), carboxylic acid groups are formed which may impair dielectric properties. Further, anhydrides are considered as sensitizing substances and their use is therefore questionable under health aspects.

In order to impair the above-mentioned disadvantages, it has been proposed to use epoxy resin compositions which are tree of anhydrides, and which are cured in the presence of a latent catalyst, e.g. a metal acetylacetonate. The term latent catalyst means that the catalyst is present as an integral part within the composition.

However, there are essential requirements for material properties and processing parameters for electrical insulation applications, especially for high voltage applications, which have to be taken into consideration. Beside a long pot life, i.e. slow curing speed at processing temperature, it is substantial that the curable epoxy resin composition has a long storage life and, at the same time a short gel time at the beginning of processing.

A long storage life means that it is possible to store the curable epoxy resin composition already containing the catalyst without occurrence of precipitation and viscosity increase, respectively. This is important since, particularly for producing electrical insulators from aromatic epoxy resin compounds, it is desirable to store pre-formulated curable epoxy resin compositions for a longer period of time without quality loss.

In principle, precipitation may occur during storage by crystallization and therefore generation of epoxy resin rich domains (i.e. catalyst poor domains) in at least parts of the curable epoxy resin composition resulting in the formation of solid precipitants having different chemical and physical properties than the rest of the curable epoxy resin composition. In the finally cured insulating material, these solid precipitants result in unpredictable quality losses due to their different electrical and mechanical properties.

The problem of viscosity increase usually arises when the resin kept in the tank or basin is used for several production runs since production processes are continuous processes using partially open tanks or basins where solvents can easily evaporate. However, for most HV applications, a low viscosity is required for proper processing. In the absence of any hardener component, such as anhydrides, the epoxy resin needs to be heated up for decreasing the viscosity at the beginning of processing. This heating up to elevated temperature, however, causes an undesired increased curing speed at processing temperature and results in a higher evaporation and increased heat consumption during processing.

A short gel time means a fast cross-linking reaction with respect to polymerization reaction at processing temperature. Fast gelling in the curing oven, i.e. after impregnation or winding, is important in order to avoid the curable epoxy resin composition dripping off the impregnated or the wet wound parts before being cured. Therefore, short gel times below 30 minutes at curing temperature are often required.

Thus, the prevention of any precipitation, a stable low viscosity under storage as well as a short get time at the beginning of processing is substantial for obtaining good quality and keeping production costs low. Further, a low dielectric loss of the finally cured insulating material within a wide temperature range is required, in particular for high voltage applications.

Epoxy rein formulations comprising an epoxy resin component, a catalyst composed of a metal acetylacetonate, and a diluent are known, e.g. from U.S. Pat. No. 4,656,090. Such epoxy resin formulations are described as providing uniquely low viscosities, long shelf lives and good electrical properties. However, these epoxy resin formulations do not show long storage life in a wide temperature range due to the occurrence of precipitation. Further, these epoxy resin formulations do not maintain a stable low viscosity (<200 mPa·s) at ambient temperatures during storage. Therefore, these epoxy resin formulations have to be processed at elevated temperatures in order to achieve a suitable low viscosity for further processing which results in a higher evaporation and increased heat consumption during processing. Thus, these ordinary epoxy resin formulations do not meet the above described substantial requirements under economic aspects for meeting high quality standards.

In view of the above, there is a need for a curable epoxy resin composition having, beside a long pot life, a long storage life and a short gel time at the beginning of processing, and which on curing yields shaped articles with low dielectric loss values, especially for processes requiring impregnation and/or wet winding applications.

### BRIEF DESCRIPTION OF THE INVENTION

As a result of intensive studies conducted taking the above described problems into consideration, the present inventors were surprised to find that by combining a bisphenol A based epoxy resin having an epoxy content ≧5.6 equ./kg, at least one reactive diluent, at least one catalyst, and optionally a filer, an anhydride-free curable epoxy resin composition is provided which exhibits superior properties. More specifically, the anhydride-free curable epoxy resin composition according to the present invention shows long storage life in a wide temperature range. This is owed to the fact that no precipitation of the anhydride-free epoxy resin occurs in the anhydride-free curable epoxy resin composition during storage, even at low temperature such as 5° C. Moreover, the viscosity of the anhydride-free curable epoxy resin composition remains low (<200 mPa·s) at ambient temperatures during storage (e.g. steady viscosity after 6 months storage at room temperature). This is highly unexpected since epoxy formulations comprising catalysts usually tend to slowly polymerize during long-term storage leading to an increased viscosity due to their high reactivity even at low temperature. Such a low viscosity allows processing at low temperature (<30° C.) resulting in low evaporation and low heat consumption during processing. In contrast, epoxy-anhydride systems—as used widely as HV insulation—have to be processed at elevated temperature (e.g. 50° C.) in order to achieve a suitable low viscosity for further processing.

Moreover, anhydride-free curable epoxy resin compositions according to the present invention are highly compatible with mica fillers resulting in anhydride-free curable epoxy resin mica composites having significant mechanical and electrical properties—outperforming analogue mixtures using standard epoxy-anhydride systems. In comparison to epoxy-anhydride systems, the claimed anhydride-free curable epoxy resin compositions allow a better interface and bonding with mica filler resulting in higher mechanical and electrical performance.

Anhydride-free curable epoxy resin compositions according to the present invention are particularly usable for high voltage (HV) insulation, such as HV insulation for main wall insulation in wound form for HV motors (and more specifically for electrical machine coils). In particular, insulating materials obtained by curing the anhydride-free curable epoxy resin composition or the anhydride-free curable epoxy resin mica composite according to present invention show excellent dielectric properties, such as low dielectric losses, thereby outperforming standard epoxy, anhydride systems used for HV insulation. So far, similar excellent dielectric properties are known for epoxy-anhydride systems only. Particularly in high voltage applications, epoxy-anhydride systems are used as thermoset resins due to the required high electrical insulation performance.

Moreover, insulating materials according to the present invention maintain these low dielectric losses even though obtained from anhydride-free curable epoxy resin composition or the anhydride-free curable epoxy resin mica composite which have been exposed to ambient conditions during storage. In contrast, insulating materials obtained from epoxy-anhydride systems exhibit increased dielectric losses after being stored at ambient conditions due to their higher polarity.

In an embodiment, an anhydride-free curable epoxy resin composition for use as high voltage (HV) insulation is provided, which comprises a bisphenol A based epoxy resin having an epoxy content ≧5.6 equ./kg, at least one reactive diluent, at least one catalyst, and optionally a filler.

In another embodiment, an anhydride-free curable epoxy resin mica composite is provided, comprising the anhydride-free curable epoxy resin composition according to the present invention and a mica compound.

In a further embodiment, an anhydride-free curable epoxy resin cellulose composite is provided, comprising the anhydride-free curable epoxy resin composition according to the present invention and a cellulose component.

In yet another embodiment, an insulating material is provided, which is obtained by curing the anhydride-free curable epoxy resin composition or the anhydride-free curable epoxy resin mica composite/anhydride-free curable epoxy resin cellulose composite according to the present invention.

Another embodiment refer to the use of an insulating material according to the present invention as HV insulation layer.

In a further embodiment, an electrical machine coil (e.g. of a motor) is provided which comprises an insulating material according to the present invention. In particular, an electrical machine coil is provided comprising conductor coils and/or windings that are insulated by an insulation layer of insulating material according to the present invention. In still another embodiment, an electrical article is provided, comprising the electrical machine coil according to the present invention.

In a further embodiment, a process for producing an anhydride-free curable epoxy resin composition is provided, comprising mixing together a bisphenol A based epoxy resin having an epoxy content ≧5.6 equ./kg, at least one reactive diluent, at least one catalyst, and optionally a filler.

In another embodiment, a process for producing an anhydride-fee curable epoxy resin composition is provided, comprising the steps of
i) providing masterbatch A comprising a first anhydride-free epoxy resin, wherein the first anhydride-free epoxy resin is a bisphenol A based epoxy resin having an epoxy content ≧5.6 equ./kg,
ii) providing masterbatch B, comprising a second anhydride-free epoxy resin.
iii) mixing masterbatch A with masterbatch B to obtain an anhydride-free curable epoxy resin composition.

Further embodiments, aspects, advantages and features of the present invention are described in the dependent claims, the description and the accompanying drawings.

In the following, if not otherwise defined, “% by weight” refers to the total weight of the respective entity (e.g. the total weight of the anhydride-free curable epoxy resin composition or the total weight of the anhydride-five curable epoxy resin mica composite). Furthermore, if not otherwise stated, all measurements were carried out at room temperature.

### BRIEF DESCRIPTION OF THE DRAWINGS

The details will be described in the following with reference to the figures.

FIG. 1 shows dielectric loss (tan delta) of fully cured epoxy formulations measured at 50 Hz.

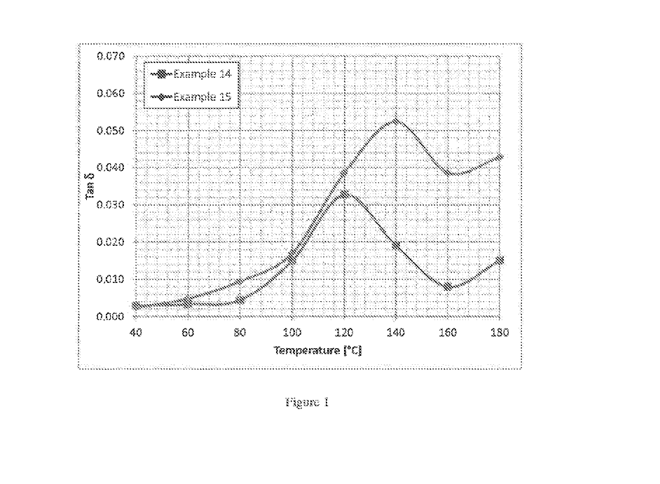

FIG. 2 shows dielectric loss (tan delta) of fully cured epoxy formulations measured at 50 Hz—samples stored for after 1 year at ambient conditions.

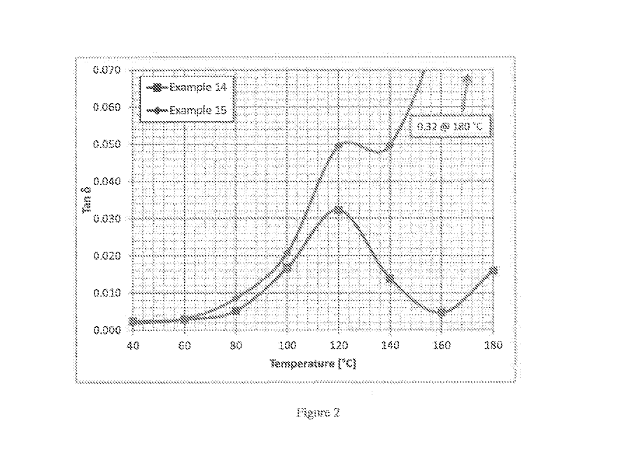

FIG. 3 shows electrical endurance tests (i.e. electrical breakdown) at room temperature and 3 U_{N} on impregnated mica tape wound 6.6 kV test bars (5 samples per example).

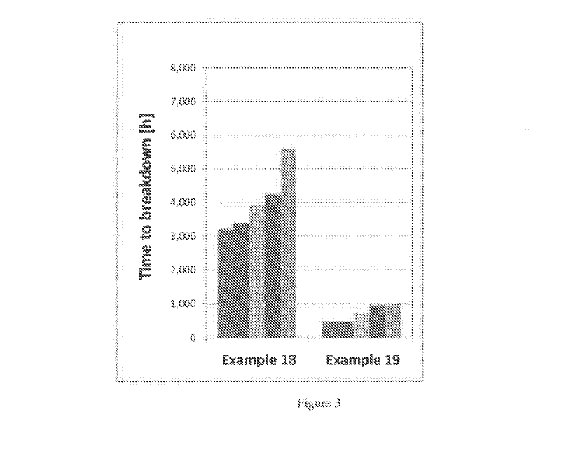

### DETAILED DESCRIPTION OF THE INVENTION

Reference will now be made in detail to various aspects of the invention and embodiments. Each aspect is provided by way of explanation and is not meant as a limitation. For example, features illustrated or described as part of one embodiment or aspect can be used on or in conjunction with any other embodiment or aspect to yield yet a further embodiment or aspect. It is intended that the present disclosure includes any such combinations and variations.

According to an embodiment, the invention relates to an anhydride-free curable epoxy resin composition for use as high voltage (HV) insulation comprising a bisphenol A based epoxy resin having an epoxy content ≧5.6 equ./kg, at least one reactive diluent, at least one catalyst, and optionally a filler.

According to an aspect, the bisphenol A based epoxy resin has an epoxy content ≧5.6 equ./kg, preferably 5.6 equ./kg to 6.2 equ./kg., more preferably 5.7 equ./kg to 6.0 equ./kg, particularly 5.8 equ./kg. The epoxy content is determined according to ISO3001. In a preferred aspect, the content of the bisphenol A based epoxy resin is 30 to 90% by weight, more preferably 30 to 60% by weight, particularly 35 to 45% by weight, based on the total weight of the epoxy resin composition. In another aspect, the content of the bisphenol A based epoxy resin is 30 to 90% by weight, more preferably 70 to 90% by weight, particularly 75 to 85% by weight, based on the total weight of the anhydride-free curable epoxy resin composition. Still, in a further aspect, the bisphenol A based epoxy resin is a low molecular weight epoxy resin having a molecular weight of from 300 to 1700 g/mol, preferably, 300 to 1100 g/mol, more preferably 340 to 680 g/mol. Due to the use of a low molecular weight of the bisphenol A based epoxy resin, the content of the reactive diluent can be held low (<25 parts with 100 parts epoxy resin). This leads to a low evaporation of the highly volatile reactive diluent during processing and better mechanical and electrical properties.

According to an aspect, the at least one reactive diluent comprises one reactive diluent, or, two or three different reactive diluents, preferably one reactive diluent. Examples of suitable reactive diluents are vinyl based reactive diluents. Vinyl based reactive diluents form the matrix material for bisphenol A based epoxy resin. In a preferred aspect, the vinyl based reactive diluents are selected from the group consisting of styrene, vinyl toluene, alpha-methyl styrene and methacrylate and combinations thereof. In a further preferred aspect, the content of the at least one vinyl based reactive diluent is ≦20% by weight, preferably 5 to 20% by weight, more preferably 7 to 15% by weight, particularly 9 to 13% by weight, based on the total weight of the anhydride-free epoxy resin composition. A low diluent content is favoured for low evaporation during processing and better mechanical and electrical properties after curing.

According to an aspect, the at least one catalyst comprises one catalyst, or, two or three different catalysts, preferably one catalyst or two different catalysts, more preferably two different catalyst. In a preferred aspect, the catalysts are selected from the group consisting of metal acetylacetonate, phenolic compound and combinations thereof. Preferably the metal acetylacetonate is aluminum acetylacetonate. Preferably, the phenolic compound is selected from the group consisting of catechol, resorcinol, hydroquinone and pyrogallol and combinations thereof, preferably catechol. In a further a preferred aspect, the content of the at least one catalyst is 2 to 10% by weight, more preferably 3 to 9% by weight, particularly 4 to 8% by weight, based on the total weight of the anhydride-free curable epoxy resin composition. According to another aspect, the at least one catalyst is dissolved in the anhydride-free curable epoxy resin composition. The catalyst described above shows good latency for epoxy resin with low reactivity at low temperature (e.g. 25° C.) and high reactivity at elevated temperature (e.g. 120° C.). In contrast, other catalyst systems for pure epoxy resin or epoxy-anhydride systems usually exhibit rather high reactivity even at low temperature (e.g. 25° C.).

According to an aspect, the anhydride-free curable epoxy resin composition further comprises at least one filler. Examples of fillers are inorganic filler such as silica and aluminum trihydrate (ATH), glass powder, chopped glass fibers, metal oxides such a silicon oxide (e.g. Aerosil, quartz, fine quartz powder), metal nitrides, metal carbides, natural and synthetic silicates. Also the average particle size distribution of such fillers and the quantity present within the composition as applied in electrical high voltage insulators are known in the art. Preferred filler materials are silica and aluminum trihydrate (ATH).

According to an aspect, the anhydride-fire curable epoxy resin composition further comprises a bisphenol F based epoxy resin having an epoxy content ≧6.2 equ./kg, preferably 6.2 equ./kg to 6.6 equ./kg, particularly 63 equ./kg. The epoxy content is determined according to ISO3001. In a further preferred aspect, the content of the bisphenol F based epoxy resin is 30 to 90% by weight, more preferably 30 to 60% by weight, particularly 35 to 45% by weight, bad on the total weight of the anhydride-free curable epoxy resin composition. Still, in an aspect, the bisphenol F based epoxy resin is a low molecular weight epoxy resin having a molecular weight of from 300 to 1600 g/mol, preferably, 300 to 1000 g/mol, more preferably 312 to 624 g/mol. In a particular preferred aspect, the bisphenol F based epoxy resin is EP158.

Depending on the type of insulator to be produced, the curable composition may further contain optional additives selected from, wetting/dispersing agents, plasticizer, antioxidants, light absorbers, as well as further additives used in electrical applications.

According to an aspect, the anhydride-free curable epoxy resin composition has an initial viscosity at 25° C. of <200 mPa*s, preferably <180 mPa*s, more preferably <150 mPa*s. According to a further aspect, the anhydride-free curable epoxy resin composition has a viscosity after 70 day storage at 25° C. of <200 mPa*s, preferably <180 mPa*s, more preferably <150 mPa*s. The viscosity is determined using a Brookfield LV DV-II+ Pro with a small sample adapter and a SC4-18 spindle. Preferably, the applied speed of the spindle is 12 rpm. The temperature is adjusted by using a circulating water bath with temperature control.

According to another aspect, the anhydride-free curable epoxy resin composition shows a viscosity increase after 70 days storage at 25° C. compared to its initial viscosity of less than 3%, preferably of less than 2%, more preferably of less than 1.5%. Therefor, the anhydride-free curable epoxy resin composition shows a negligible viscosity increase after storage. In other words, the anhydride-free curable epoxy resin composition of the present invention shows a steady viscosity after 70 day storage at 25° C., preferably after 6 months storage at 25° C. Therefore, the anhydride-free curable epoxy resin composition can be processed at low temperature (e.g. 25° C.) which results in a low evaporation and low heat consumption.

According to a further aspect, the anhydride-free curable epoxy resin composition shows no precipitation (i.e. is precipitation-free). For the purpose of this application, precipitation is determined after 6 months storage at 25° C. as well as after 6 months storage at 7° C. and −7° C. This is highly unexpected, since, in known curable anhydride-free epoxy resin compositions, at least parts of the curable epoxy resin composition usually tend to precipitate during storage. Precipitation within the curable epoxy resin composition can be either determined by visual observation, or, by centrifugation with 3000-10000 rpm. In case of the latter, precipitation is understood to occur when at least 1 wt-% of solid precipitate based on the total weight of the anhydride-free curable epoxy resin composition is determined by generally known methods such as gravimetry.

According to an aspect, the anhydride-free curable epoxy resin composition shows no gelling upon storage within 3 months, preferably within 5 months, more preferably within 6 months, at 100° C. to 160°, preferably at 110° C. to 150°, more preferably at 120° C. to 140°. This provides the basis for a long storage life and allows the anhydride-free curable epoxy resin composition already containing the catalyst to be stored for a longer period of time without any quality loss.

According to another aspect, the gel time of the anhydride-free curable epoxy resin composition (at the beginning of processing) is 10 minutes to 30 minutes, preferably 12 minutes to 25 minutes, more preferably 15 minutes to 20 minutes, at 100° C. to 140°, preferably at 110° C. to 130°, particularly at 120°. According to further aspect, the gel time of the anhydride-free curable epoxy resin composition (at the beginning of processing) is 5 minutes to 20 minutes, preferably 7 minutes to 15 minutes, more preferably 8 minutes to 12 minutes at 120° C. to 160°, preferably at 130° C. to 150°, particularly at 140°. This short gel time reflects the fast polymerization reaction at processing temperature which prevents the curable epoxy resin composition from dripping off the impregnated or the wet wound parts before being cured.

The gel time/gelling is determined by a sample of 5 g resin in a cylindrical 10 mL glass-vial (ca. 2 cm diameter) kept in an oven at the 120° C. and 140° C. respectively. The gel time/gelling is determined by observation (i.e. no resin flow when held upside down).

According to a further aspect, the anhydride-free curable epoxy resin composition according to the present invention, exhibits, after curing, a standard deviation of Tg of at most ±5.0° C. preferably at most ±4.0° C., more preferably at most ±3.0° C. Tg is defined as the glass transition temperature and is determined as defined below in paragraph [0054].

According to a further embodiment, the present invention refers to an anhydride-free curable epoxy resin mica composite comprising the anhydride-free curable epoxy resin composition according to the present invention and a mica compound.

The anhydride-free curable epoxy resin mica composite comprising the mica compound, preferably dispersed therein, can be used at cast resin showing significant Increase of Young modulus with only slight reduction of flexural strength. In contrast, analogue cast resins based on standard HV epoxy-anhydride system show smaller increase of modulus and greater reduction of mechanical strength.

According to an aspect, the mica compound is dispersed in the composite. Preferably, the mica compound is epoxy-silane treated. The epoxy-silane treatment leads to an increased wettability of the mica compound with the anhydride-free curable epoxy resin composition. This increased wettability together with the low polarity of the anhydride-free curable epoxy resin composition according to the present invention results in a high interface compatibility of mica compound and anhydride-free epoxy resin providing high performance (mechanically and electrically) composite materials after polymerization/curing.

According to a further aspect, the mica compound has an average particle size of 1 μm to 10 μm, preferably, 2 μm to 8 μm, particularly 3 μm to 6 μm. Preferably, the content of the dispersed mica compound is 20 to 50% by weight, more preferably 25 to 45% by weight, particularly 30 to 40% by weight, based on the total weight of the anhydride-free curable epoxy resin mica composite. In a particular preferred aspect, the mica compound is Tremica 1155-010 EST.

Accordingly, the content of the anhydride-free curable epoxy rein composition is preferably 50 to 80% by weight, more preferably 55 to 75% by weight, particularly 60 to 70% by weight based on the total weight of the composite.

According to an alternative aspect, the anhydride-free curable epoxy resin mica composite is a mica tape impregnated with the anhydride-free curable epoxy composition. Preferably, the mica tape is a non-accelerated mica tape. More preferably, the mica tape comprises a glass support. In a particular aspect, the mica tape comprises 65 to 90% by weight, preferably 70 to 88% by weight, particularly preferably 75 to 85% by weight mica, and 10 to 35% by weight, preferably 12 to 30% by weight, particularly preferably 15 to 25% by weight glass, based on the total weight of the mica tape. Yet in a further preferred aspect, the mica tape comprises 140 to 180 g/m², preferably 150 to 170 g/m², more preferably 155 to 165 g/m² mica, and 15 to 55 g/m², preferably 25 to 45 g/m², more preferably 30 to 40 g/m² glass. Even more preferably, the mica tape consists of 140 to 180 g/m², preferably 150 to 170 g/m², more preferably 155 to 165 g/m² mica and 15 to 55 g/m², preferably 25 to 45 g/m², more preferably 30 to 40 g/m² glass. In a particular preferred aspect, the mica tape is Samicapor 366.58.

According to a further embodiment, the present Invention refers to an anhydride-free curable epoxy resin cellulose composite comprising the anhydride-free curable epoxy resin composition according to the present invention and a cellulose component. According to a preferred aspect, the anhydride-free curable epoxy resin cellulose composite is a cellulose component impregnated with the anhydride-free curable epoxy composition.

According to another embodiment, an insulating material is obtained by curing the anhydride-free curable epoxy resin composition or the anhydride-free curable epoxy resin mica composite according to present invention or anhydride-free curable epoxy resin cellulose composite according to the present invention.

According to a preferred aspect, curing comprises heat curing or radiation curing, preferably heat curing. According to an aspect, heat curing is performed in a first curing step in an oven at 110° C. to 150° C. preferably at 115° C. to 140° C. for 2 to 6 hours, preferably for 3 to 5 hours. Optionally, a second curing step can be performed subsequent to the first curing step in an oven at 150° C. to 180° C., preferably at 155° C. to 170° C., for 6 to 24 hours, preferably for 7 to 10 hours.

According to an aspect, the insulating material has a dielectric loss of <0.1, preferably <0.08, more preferably <0.05, measured at 50 Hz in a temperature range of from 40° C. to 200° C. Such excellent dielectric properties are known so far only for epoxy-anhydride systems. In addition, insulating materials according to the present invention maintain these low dielectric losses even though they have been produced from anhydride-free curable epoxy resin compositions or the anhydride-free curable epoxy resin mica composites/anhydride-free curable epoxy resin cellulose composites stored at ambient conditions for up to 1 year at increased temperatures (i.e. >160° C.). In contrast, insulating materials obtained from epoxy-anhydride systems exhibit increased dielectric losses after storage under comparable conditions. Such beneficial electrical properties are usually not obtained for anhydride-free epoxy systems containing reactive diluent(s), but rather for ordinary epoxy-anhydride systems.

According to a further aspect, the insulating material has a Young's modulus of 2000 to 10000 MPa, preferably 2500 to 9000 MPa, more preferably 3000 to 8000 MPa. The Young's modulus is determined according to ISO 527-2.

Still, according to a further aspect, the insulating material has a flexural strength of 60 to 150 MPa, preferably of 70 to 140 MPa, more preferably of 80 to 130 MPa. The flexural strength is determined according to ISO 178.

According to an aspect, the insulating material has a deformation at break of 0.9 to 5.0 MPa, preferably 1.0 to 4.5 MPa, more preferably 1.1 to 4.0 MPa. The deformation at break is determined according to ISO 178.

According to an aspect, the insulating material shows electrical endurance for at least 1 hour, preferably 2 hours, more preferably 3 hours before breakdown. The time to breakdown can e.g. be determined according to an electrical endurance test at 3 UN on impregnated mica tape wound 6.6 kV test bars (or impregnated cellulose component wound 6.6 kV test bars).

According to an aspect, the insulating material shows no precipitation. In other words, the insulating material according to the present invention exhibits a homogeneous degree of polymerization and network density. This leads to uniform material properties throughout the whole insulating material. Therefore, articles obtained therefrom comply with high quality standards. Without being bound to theory, the prevention of precipitation within the inventive insulating material is inter alia based on the fact that the anhydride-free curable epoxy resin composition according to the present invention exhibits a rather homogeneous molecular network derived from epoxy resin polymerization. This homogeneous molecular network obtained by polymerizing the epoxy resin lays the foundation of the insulating material's homogeneous degree of polymerization and network density (i.e. after curing) leading to the above-mentioned excellent insulation properties. This is rather unexpected since ordinary insulating materials (obtained by curing epoxy resin formulations) usually tend to exhibit domains having different degrees of polymerization and network density. Said domains generally are on a length scale of 1 to 5000 μm, preferably 1 to 1000 μm. These domains within ordinary cured insulating materials are formed, since before curing, the molecular network derived from epoxy resin polymerization of ordinary epoxy resin compositions is usually inhomogeneous. This inhomogeneity is owed to the fact that epoxy-resin rich domains (i.e. catalyst poor domains) alternate with epoxy-resin poor domains (or catalyst rich domains) within the ordinary epoxy resin compositions.

One way to determine whether cured epoxy resin compositions (i.e. the insulating materials) have such a homogeneous degree of polymerization and network density is to measure their glass transition temperature (Tg) and its variance. Accordingly, in a preferred aspect, the insulating material according to the present invention exhibits a glass transition temperature (Tg) of 105° C. to 140° C., preferably of 110° C. to 130° C., more preferably of 115° C. to 125° C. The glass transition temperature of the insulating material is measured according to ASTM E1356-08 standard. In particular, the glass transition temperature of the insulating material is measured with samples of 3×3 mm size from insulating material plates of 1×150×150 mm using differential scanning calorimetry (DSC) with 20 K/min heating rate.

In a further preferred aspect, the insulating material according to the present invention exhibits a small variation in Tg. A variation in Tg is understood as a standard deviation for Tg values measured for at least 5 individual samples of 1×150×150 mm plates of the insulating material (wherein the size of each sample is preferably 3×3 mm). The standard deviation is a measure to determine the insulating material's inhomogeneity. The standard deviation a for Tg values is defined as according to the following formula

$$σ = \sqrt{\frac{1}{N} {\sum }_{i = 1}^{N} {( {x}_{i} - μ )}^{2} ,} where μ = \frac{1}{N} {\sum }_{i = 1}^{N} {x}_{i} ,$$

Therein, N is the number of samples, xᵢ is the Tg value of an individual sample and μ is the mean value of all Tg values. In principle, the higher the standard deviation of the glass transition temperature determined for individual insulating material samples, the more inhomogeneous the molecular structure of the insulating material with respect to degree of polymerization and network density.

Accordingly, the standard deviation of Tg concerning the inventive insulation material is preferably at most ±5.0° C., preferably at most ±4.0° C., more preferably at most ±3.0° C.

Another embodiment of the present invention relates to the use of an insulating material as described above as HV insulation layer.

According to an embodiment, the present invention also refers to an electrical machine coil comprising a HV insulation layer of insulating material as described above. Preferably, the insulation layer is used as main wall insulation. More preferably, the insulation layer has a thickness of more than 5 mm, preferably, more than 10 mm, more preferably more than 15 mm.

According to an embodiment, the present invention also relates to an electrical article comprising the above described electrical machine coil.

According to a further embodiment, the present invention also relates a process for producing an anhydride-free curable epoxy resin composition.

In a preferred aspect, the process for producing the anhydride-free curable epoxy resin composition comprises mixing together a bisphenol A based epoxy resin having an epoxy content ≧5.6 equ./kg, at least one reactive diluent, at least one catalyst, and optionally a filler. According to a further preferred aspect, the process for producing the anhydride-free curable epoxy resin composition comprises mixing together a bisphenol A based epoxy resin having an epoxy content ≧5.6 equ./kg, bisphenol F based epoxy resin, at least one reactive diluent, at least one catalyst, and optionally a filler. All before-mentioned components are further defined in the preceding paragraphs. Preferably, mixing together the above-mentioned components is performed at elevated temperatures in an oven, preferably at 30° C. to 70° C. more preferably at 40° C. to 60° C. According to a further preferred aspect, mixing the above-mentioned components is performed for 1 to 8 hours, preferably for 2 to 6 hours, more preferably for 3 to 5 hours.

In another aspect, the process for producing an anhydride-tie curable epoxy resin composition comprises the steps of
i) providing masterbatch A comprising a first anhydride-free epoxy resin, wherein the first anhydride-free epoxy resin is a bisphenol A based epoxy resin having an epoxy content ≧5.6 equ./kg,
ii) providing masterbatch B, comprising a second anhydride-free epoxy rein,
iii) mixing masterbatch A with masterbatch B to obtain an anhydride-fee curable epoxy resin composition.

According to an aspect, masterbatch A and masterbatch B are the same. Alternatively, masterbatch A and masterbatch B are different.

According to an aspect, step i) comprises the steps of
providing a bisphenol A based epoxy resin having an epoxy content ≧5.6 equ./kg,
mixing the bisphenol A based epoxy resin with a catalyst to obtain a mixture A,
mixing a reactive diluent and optionally a filler with mixture A to obtain masterbatch A.

According to another aspect, step ii) comprises the steps of
providing a second anhydride-free epoxy resin,
mixing the second anhydride-free epoxy resin with a catalyst to obtain a mixture B,
mixing a reactive diluent and optionally a filler with mixture B to obtain masterbatch B.

According to a further aspect, in step i) providing a bisphenol A based epoxy resin comprises heating a solid bisphenol A based epoxy resin until melting followed by cooling down to room temperature. According to a preferred aspect, heating is performed at 40 to 100° C., preferably at 50° C. to 90° C. more preferably at 60° C. to 80° C. According to a further preferred aspect, heating is performed for 1 to 10 hours, preferably for 2 to 8 hours, more preferably for 4 to 6 hours.

According to an aspect, in step ii) providing a second anhydride-free epoxy resin comprises beating a solid second anhydride-free epoxy resin until melting followed by cooling down to room temperature. According to a preferred aspect, heating is performed at 40° C. to 100° C., preferably at 50° C. to 90° C., more preferably at 60° C. to 80° C. According to a further preferred aspect, beating is performed for 1 to 10 hours, preferably for 2 to 8 hours, more preferably for 4 to 6 hours.

According to an aspect, mixing the bisphenol A based epoxy resin with a catalyst in step i) is performed in a weight ratio bisphenol A based epoxy resin to catalyst of between 5:1 to 20:1, preferably of between 8:1 to 15:1, more preferably of between 10:1 to 13:1. Preferably, mixing the bisphenol A based epoxy resin with a catalyst in step i) is performed at elevated temperatures in an oven, preferably at 30° C. to 70° C., more preferably at 40° C. to 60° C. According to a further preferred aspect, mixing the bisphenol A based epoxy resin with a catalyst in step i) is performed for 1 to 8 hour, preferably for 2 to 6 hours, more preferably for 3 to 5 hours. Sufficient mixing is important for avoiding the formation of precipitation in the finally anhydride-free curable epoxy resin composition. Still, according to a preferred aspect, mixing the bisphenol A based epoxy resins with a catalyst in step i) is performed with a propeller mixer, an ultrasonic device or a shaker, preferably with a propeller mixer.

According to an aspect, mixing the second the anhydride-free based epoxy resins with a catalyst in step ii) is performed in a weight ratio second anhydride-free based epoxy resins:catalyst of between 5:1 to 20:1, preferably of between 8:1 to 15:1, more preferably of between 10:1 to 13:1. According to a further aspect, mixing the second the anhydride-free based epoxy resins with a catalyst in step ii) is performed at elevated temperatures in an oven, preferably at 30° C. to 70° C., more preferably at 40° C. to 60° C. According to a further preferred aspect, mixing the second the anhydride-free based epoxy resins with a catalyst in step ii) is performed for 1 to 8 hour, preferably for 2 to 6 hours, more preferably for 3 to 5 hours. Sufficient mixing is important for avoiding the formation of precipitation in the finally anhydride-free curable epoxy resin composition. Still, according to a preferred aspect, mixing the second the anhydride-free based epoxy resins with a catalyst in step ii) is performed with a propeller mixer, an ultrasonic device or a shaker, preferably with a propeller mixer.

According to an aspect, mixing a reactive diluent and optionally a filer with mixture A/mixture B to obtain masterbatch A/masterbatch B in step i) and/or step ii) is performed in a weight ratio mixture A/mixture B: reactive diluent of between 4:1 to 12:1, preferably of between 5:1 to 10:1, more preferably of between 6:1 to 8:1. According to a further aspect, mixing a reactive diluent and optionally a filler with mixture A/mixture B to obtain masterbatch A/masterbatch B in step i) and/or step ii) is performed at room temperature. According to a further preferred aspect, mixing a reactive diluent and optionally a filer with mixture A/mixture B to obtain masterbatch A/masterbatch B in step i) and/or step ii) is performed for 15 minutes to 3 hours, preferably for 30 minutes to 2 hours, particularly for 1 hour. According to a further preferred aspect, mixing a reactive diluent and optionally a filler with mixture A/mixture B to obtain masterbatch A/masterbatch B in step i) and/or step ii) is performed with a propeller mixer, an ultrasonic device or a shaker, preferably with a propeller mixer.

According to an aspect, the second anhydride-free epoxy resin is selected from the group consisting of Bisphenol A based epoxy resin. Bisphenol F based epoxy resin, and a combination thereof. According to a further preferred aspect the second anhydride-free epoxy resin is a bisphenol A based epoxy resin having an epoxy content ≧5.6 equ./kg, preferably 5.6 equ./kg to 6.2 equ./kg, more preferably 5.7 equ./kg to 6.0 equ./kg, particularly 5.8 equ./kg. Still, according to a further preferred aspect, the second anhydride-free epoxy resin is a bisphenol F based epoxy resin having an epoxy content ≧6.2 preferably 6.2 equ./kg to 6.6 equ./kg, particularly 6.3 equ./kg.

Optionally, the two masterbatches A and B obtained in steps i) and ii) are stored separately at a temperature of between 5° C. to 80° C., preferably, of between 15° C. to 60° C., more preferably at 20 to 30° C. During separate storage, a stable low viscosity within masterbatch A and masterbatch B is maintained for a longer period of time (e.g. 70 days). At the same time, no gelling occurs upon storage (e.g. within 3 months at 120° C. and 140° C., respectively). These properties are rather unexpected since masterbatch A and masterbatch B already contain a catalyst which usually initiates cross-linking reactions of the respective epoxy resins, thereby starting the gelling reaction. These unexpected properties of masterbatch A and masterbatch B lay the cornerstone for a prolonged storage life and the quality assurance.

According to an aspect, mixing masterbatch A with masterbatch B in step iii) is performed in a weight ratio masterbatch A:masterbatch B of between 1:5 to 5:1, preferably 12 to 2:1, particularly 1:1. According to a further preferred aspect, mixing masterbatch A with masterbatch B in step iii) is performed at room temperature. According to a preferred aspect, mixing masterbatch A with masterbatch B in step iii) is performed is performed for 1 to 8 hours, preferably for 2 to 6 hours, move preferably for 3 to 5 hours. Still, according to a preferred aspect, mixing masterbatch A with masterbatch B in step iii) is performed with a propeller mixer, an ultrasonic device or a shaker, preferably with a propeller mixer.

Mixing of masterbatch A with masterbatch B results into a latent reactive epoxy resin system. If necessary, at least one reactive diluent described above can be further added within the above described content.

According to a further aspect, the process for producing an anhydride-free curable epoxy resin composition further comprises a further step (i.e. step iv)) of bringing the reactive anhydride free epoxy resin composition obtained in contact with a mica compound to obtain an anhydride-free curable epoxy resin mica composite. According to a further preferred aspect, step iv) comprises mixing the reactive anhydride-free curable epoxy resin composition obtained in the process according to the present invention (e.g. obtained in step iii)) with a mica compound. Preferably, mixing the anhydride-free curable epoxy resin composition with a mica compound is performed in a weight ratio anhydride-free curable epoxy resin composition:mica compound of between to 5:1 to 1:2, preferably, of between 4:1 to 1:1, particularly of between 3:1 to 1:1. According to a preferred aspect, mixing the anhydride-free curable epoxy rein composition with a mica compound is performed at room temperature. According to a further preferred aspect, mixing the anhydride-free curable epoxy resin composition with a mica compound is performed in a vacuum chamber, preferably at 80 to 120 mbar, more preferably at 90 to 110 mbar, particularly at 100 mbar. Still, according to a preferred aspect, mixing the anhydride-free curable epoxy resin composition with a mica compound is performed for 1 to 5 hours, preferably for 2 to 4 hours, particularly for 3 hours. Further, according to a preferred aspect, mixing the anhydride-free curable epoxy resin composition with a mica compound is performed with a propeller mixer, an ultrasonic device or a shaker, preferably with a propeller mixer.

According to an alternative aspect, step iv) comprises impregnating a mica tape with the anhydride-free curable epoxy resin composition obtained the process according to the present invention (e.g. obtained in step iii)). Preferably, impregnating is performed in a vacuum pressure impregnation process. According to a preferred aspect, the mica tape is already applied on an electrical conductor. e.g. by winding.

According to another aspect, the process for producing an anhydride-free curable epoxy resin composition according to the present invention further comprises the step of (i.e. step iv)) bringing the reactive anhydride-free epoxy resin composition in contact with a cellulose component. According to a preferred aspect, said step (i.e. step iv)) comprises impregnating a cellulose component with the anhydride-free curable epoxy resin composition obtained according to the present invention, e.g. obtained in step iii). Preferably, impregnating is performed in a vacuum pressure impregnation process. Preferably, said impregnated cellulose can be used for bushings and transformers.

According to a further preferred aspect, the process for producing an anhydride-free curable epoxy resin composition according to the present invention also comprises a further step (i.e. step v)) of curing the anhydride-free curable epoxy resin composition obtained according to the present invention (e.g. obtained in step ii)) or the anhydride-free curable epoxy resin mica composite/anhydride-free curable epoxy resin cellulose composite of iv) to obtain an insulating material. Curing is performed under the above described conditions.

The present invention shall be described in more detail in the following Examples.

### EXAMPLES

### Production of Anhydride-Free Curable Epoxy Resin Compositions

In the following experiments, anhydride-free curable epoxy resin compositions were manufactured in line with the process according to the present invention (Examples 1-12). Anhydride-free curable epoxy resin compositions according to the present invention were analyzed with respect to viscosity and gelling properties as described in details in the following. As Comparative Examples (Comparative Example 13a, 13b and 13c), a standard epoxy-anhydride formulation for HV insulation was produced. Standard epoxy-anhydride formulation for HV insulation was analyzed with respect to viscosity properties as described in details in the following.

Viscosity

Viscosity is measured using a Brookfield LV DV-II+ Pro with a small sample adapter and a SC4-18 spindle—the same setup as used at FIDRI. Preferable applied speed of the spindle was 12 rpm. The temperature was adjusted by using a circulating water bath with temperature control.

Gel Time

A sample of 5 g resin in a cylindrical 10-mL-glass-vial (ca. 2 cm diameter) was kept in an oven at the required temperature. Gel time was detected by observation (no resin flow when held upside down).

### Example 1

1. The solid fresh epoxy resin EP158 was heated at 70° C. for 4-6 hours for melting and liquefaction and cooled down to room temperature.
2. Masterbatch A: Catechol (4 g) was added to liquid epoxy resin (50 g) placed in a beaker, and the mixture mixed for 4 hours at 50° C. in an oven using a propeller mixer.
3. The mixture was cooled down to room temperature and styrene (7 g) was added. The mixture was mixed for 1 hour using a propeller mixer.

### Example 2

1. The solid fresh epoxy resin EP158 was heated at 70° C. for 4-6 hours for melting and liquefaction and cooled down to room temperature.
2. Masterbatch A: Catechol (4 g) was added to liquid epoxy resin (50 g) placed in a beaker, and the mixture mixed for 1 hour at 50° C. using a propeller mixer.
3. The mixture was cooled down to room temperature and styrene (7 g) was added. The mixture was mixed for 1 hour using a propeller mixer.

### Example 3

1. The solid fresh epoxy resin EP158 was heated at 70° C. for 4-6 hours for melting and liquefaction and cooled down to room temperature.
2. Masterbatch A: Catechol (4 g) was added to liquid epoxy resin (50 g) placed in a beaker, and the mixture mixed for 4 hours at room temperature using a propeller mixer.
3. Then styrene (7 g) was added. The mixture was mixed for 1 hour using a propeller mixer.

### Example 4

1. The solid fresh epoxy resin EP158 was heated at 70° C. for 4-6 hours for melting and liquefaction and cooled down to room temperature.
2. Masterbatch B: Aluminium acetylacetonate (0.5 g) was added to liquid epoxy resin (50 g) placed in a beaker, and the mixture mixed for 4 hours at 50° C. in an oven using a propeller mixer.
3. Styrene (7 g) was added to the mixture which was stirred for another 1 hour at 50° C. using a propeller mixer.

### Example 5

1. The solid fresh epoxy resin EP158 was heated at 70° C. for 4-6 hours for melting and liquefaction and cooled down to mom temperature.
2. Masterbatch B: Aluminium acetylacetonate (0.5 g) was added to liquid epoxy resin (50 g) placed in a beaker, and the mixture mixed for 1 hour at 50° C. in an oven using a propeller mixer.
3. Stylene (7 g) was added to the mixture which was stirred for another 1 hour at 50° C. using a propeller mixer.

### Example 6

1. The solid fresh epoxy resin EP158 was heated at 70° C. for 4-6 hours for melting and liquefaction and cooled down to mom temperature.
2. Masterbatch B: Aluminium acetylacetonate (0.5 g) was added to liquid epoxy resin (50 g) placed in a beaker, and the mixture mixed for 4 hour at 50° C. in an oven using a propeller mixer.
3. The mixture was cooled down to room temperature and styrene (7 g) was added. The mixture was mixed for 1 hour using a propeller mixer.

### Example 7

1. The solid fresh epoxy resin EP158 was heated at 70° C. for 4-6 hours for melting and liquefaction and cooled down to room temperature.
2. Masterbatch B: Aluminium acetylacetonate (0.5 g) was added to liquid epoxy resin (50 g) placed in a beaker, and the mixture mixed for 4 hours at room temperature in an oven using a propeller mixer.
3. Then styrene (7 g) was added. The mixture was mixed for 1 hour using a propeller mixer.

### Example 8

1. Masterbatch 1 (Example 1) and masterbatch 2 (Example 2) were mixed together at room temperature using a propeller mixer.

### Example 9

1. The solid fresh epoxy resin EP158 was heated at 70° C. for 4-6 hours for melting and liquefaction and cooled down to room temperature.
2. Catechol (4 g) and aluminium acetylacetonate (0.5 g) were added to liquid epoxy resin (100 g) placed in a beaker, and the mixture mixed for 4 hours at 50° C. using a propeller mixer.
3. Styrene (14 g) was added to the mixture which was stirred for another 1 hour at 50° C. using a propeller mixer.

### Example 10

1. The solid fresh epoxy resin EP158 was heated at 70° C. for 4-6 hours for melting and liquefaction and cooled down to room temperature.
2. Catechol (4 g) and aluminium acetylacetonate (0.5 g) were added to liquid epoxy resin (100 g) placed in a beaker, and the mixture mixed for 4 hours at 50° C. using a propeller mixer.
3. The mixture was cooled down to room temperature and styrene (14 g) was added. The mixture was mixed for 1 hour using a propeller mixer.
Example 11
1. The solid fresh epoxy resin EP158 was heated at 70° C. for 4-6 hours for melting and liquefaction and cooled down to room temperature.
2. Catechol (4 g) and aluminium acetylacetonate (0.5 g) were added to liquid epoxy resin (100 g) placed in a beaker, and the mixture mixed for 1 hour at 50° C. using a propeller mixer.
3. Styrene (14 g) was added to the mixture which was stirred for another 1 hour at 50° C. using a propeller mixer.

### Example 12

1. The solid fresh epoxy resin EP158 was heated at 70° C. for 4-6 hours for melting and liquefaction and cooled down to room temperature.
2. Catechol (4 g) and aluminium acetylacetonate (0.5 g) were added to liquid epoxy resin (100 g) placed in a beaker, and the mixture mixed for 4 hours at room temperature using a propeller mixer.
3. Then and styrene (14 g) was added. The mixture was mixed for 1 hour using a propeller mixer.

### Comparative Example 13a

### Standard Epoxy-Anhydride Formulation for HV

1. The solid fresh epoxy resin was heated at 70° C. for 46 hours for melting and liquefaction and cooled down to room temperature.
2. The anhydride (90 g) was added to liquid epoxy resin (100 g) placed in a beaker, and the mixture was mixed for 1 hour 50° C. using a propeller mixer.
3. The catalyst Soligen zinc 11/12 (10 g) was added. The mixture was mixed for further 30 minutes at 50° C.° using a propeller mixer.

### Comparative Example 13b

### Standard Anhydride-Free Epoxy Formulation for HV (According to U.S. Pat. No. 4,656,090)

1. The solid fresh epoxy resin EPON 828 was heated at 70° C. for 4-6 hours for reciting and liquefaction and cooled down to room temperature.
2. Catechol (4 g) and aluminium acetylacetonate (0.5 g) were added to liquid epoxy resin (100 g) placed in a beaker, and the mixture mixed for 4 hours at room temperature using a propeller mixer.
3. Then and styrene (12 g) was added. The mixture was mixed for 1 hour using a propeller mixer.

### Comparative Example 13c

### Standard Anhydride-Free Epoxy Formulation for HV

1. The solid fresh epoxy resin EPON 828 was heated at 70° C. for 4-6 hours for melting and liquefaction and cooled down to room temperature.
2. Catechol (4 g) and aluminium acetylacetonate (0.5 g) were added to liquid epoxy resin (100 g) placed in a beaker, and the mixture mixed for 4 hours at room temperature using a propeller mixer.
3. Then and styrene (17 g) was added. The mixture was mixed for 1 hour using a propeller mixer.

Production of Insulating Materials

In the following experiments, insulating materials were manufactured in line with the process according to the present invention (Examples 14, 16, 18). As Comparative Example (Comparative Examples 15, 17 and 19), standard insulating materials based on epoxy-anhydride formulations were produced. Insulating materials according to the present invention as well as standard insulating materials were analyzed with respect to mechanical and electrical properties, as well as with respect to glass transition temperatures as described in details in the following.

3-Point-Bending on Epoxy/Mica Composites

Mechanical tests were performed on a Zwick SMZ 100 according to ISO 178 using a 5 kN load cell, a test speed of 10 mm/min and a span length of 64 mm.

Electrical Endurance on Test Bars Wound with Mica Tape and Impregnated with Epoxy

A constant voltage of 19.8 kV were applied on the manufactured electrical test bars (see below) under ambient temperature, and the time to breakdown (electrical endurance) was recorded. With a thickness of the epoxy/mica tape Insulation of 1.5 mm the resulting stress was 13.2 kV/mm.

Determination of Glass Transition Temperatures

Small pieces (3×3 mm pieces from 1×150×150 mm plates) taken from cured samples (Examples 8 and 10) were analyzed with respect to their glass transition temperatures using differential scanning calorimetry (DSC) with 12 K/min beating rate according to ASTM 1356.08. Each value (cf. Table 5) represents the average glass transition temperature for one sample piece of the finally curd product. Curing was performed for 4 hours at 130° C. followed by 16 hours at 160° C.

The results of the above described tests are shown in Tables 1-5 below:

TABLE 1
Precipitation of exemplary epoxy formulations stored
at 25° C. (ambient) and 7° C. (refrigerator)

| | Time until | Time until |
|---|---|---|
| | precipitation | precipitation |
| | at 25° C. | at 7° C. |
| Example 1 | >6 months | >6 months |
| Example 4 | >6 months | >6 months |
| Example 8 | >6 months | >6 months |
| Example 9 | >6 months | >6 months |
| Example 10 | within 1 week | within 2-3 days |
| Example 11 | within 2 months | within 1 week |
| Example 12* | within 1 day | within 1 day |

*Catechol did not dissolve in pure epoxy resin, only after addition of styrene and stirring (until precipitation occurs.

TABLE 2
Viscosity increase at specific storage and processing temperature

| | | | Viscosity |
|---|---|---|---|
| | | Viscosity | after |
| | | at start | 70 days |
| | Temperature | (0 days) | storage |
| Example 1 | 25° C. | 148 ± 2 mPa · s | 148 ± 1 mPa · s |
| | | | (no increase) |
| Example 4 | 25° C. | 143 ± 1 mPa · s | 143 ± 1 mPa · s |
| | | | (no increase) |
| Example 8 | 25° C. | 145 ± 1 mPa · s | 159 ± 1 mPa · s |
| | | | (increase by factor 1.10) |
| Example 9 | 25° C. | 147 ± 2 mPa · s | 164 ± 3 mPa · s |
| | | | (increase by factor 1.12) |
| Comparative | 50° C. | 56 | 1820 ± 20 mPa · s |
| Exanple 13a^{#} | | | (increase by factor 32.5) |
| Comparative | 25° C. | 521 ± 2 mPas | 1020 ± 20 mPa · s |
| Example 13b^{#} | | | (increase by factor 1.96) |
| Comparative | 25° C. | 275 ± 3 mPas | 1320 ± 20 mPa · s |
| Example 13c^{#} | | | (increase by factor 4.8) |

^{#}Standard insulation system used for impregnating form-wound coils used in HV machines using recommended processing parameters

TABLE 3
Determination of gel time

| | Gel time at 120° C. | Gel time at 140° C. |
|---|---|---|
| Example 1 | no gelling for >3 months | no gelling for >3 months |
| Example 4 | no gelling for >3 months | no gelling for >3 months |
| Example 8 | 17 ± 3 min | 10 ± 2 min |

TABLE 4
Flexural characteristics of mica composites

| | | Flexural strength | Deformation |
|---|---|---|---|
| | Young Modulus | (stress at break) | at break |
| Example 14 | 3229 ± 69 MPa | 120 ± 8 MPa | 3.5 ± 0.9% |
| Example 16 | 7680 ± 98 MPa | 90 ± 12 MPa | 1.2 ± 0.2% |
| | Increase: +138% | Reduction: −25% | Reduction: −66% |
| Example 15 | 3360 ± 24 MPa | 123 ± 8 MPa | 3.4 ± 0.2% |
| Example 17 | 6170 ± 13 MPa | 55 ± 1 MPa | 0.9 ± 0.0 |
| | Increase: +84% | Reduction: −55% | Reduction: −74% |

TABLE 5
Glass transition temperatures of finally cured product
Example 8 w/o precipitaiton
120° C.
118° C.
123° C.
115° C.
117° C.
116° C.
119° C.
121° C.

Result

As can be particularly seen from Examples 1, 4, 8 and 9, the specific anhydride-free curable epoxy resin composition according to the present invention exhibits a stable low viscosity (<200 mPa*s) at ambient temperatures during storage (e.g. steady viscosity after 6 months storage at room temperature). Moreover, the anhydride-free curable epoxy resin composition according to the present invention shows no precipitation after 6 months storage at room temperature and at decreased temperatures (i.e. 7° C.), respectively (see particularly Examples 1, 4, 8 and 9). Further, the anhydride-free curable epoxy resin composition according to the present invention shows no gelling upon storage respectively within 3 months as well as a short gel time (<30 minutes) at the beginning of processing at 120° C. and 140° C. respectively (see Table 3 above). These beneficial properties allow manufacturers to store the curable epoxy resin composition already containing the catalyst for a longer period of time without any quality loss, and at the same time, enable fast gelling in the curing oven, in order to avoid the curable epoxy resin composition dripping off the impregnated or the wet wound parts before being cured leading to good quality low production costs. Results concerning precipitation on finally cured insulating materials (see Table 5 above) show that there is a small variation in Tg between individual sample pieces of products according to the present invention (i.e. standard deviation of ±2.9). Further, the finally cured insulating materials according to the present invention exhibit excellent mechanical and electrical properties (e.g. low dielectric loss within a wide temperature range) thereby meeting the requirements for high voltage applications (cf. Table 4 above).

In view of the above, the polymer composition according to the present invention stands out with superior storage properties, and which on curing yields shaped articles with low dielectric loss values which are particularly useful as high voltage (HV) insulation, in particular as HV insulation for main wall insulation.

1. Anhydride-free curable epoxy resin composition for use as insulation, comprising
a bisphenol A based epoxy resin having an epoxy content ≧5.6 equ./kg,
at least one reactive diluent, and
at least one catalyst.

2. Anhydride-free curable epoxy resin composition according to claim 1, wherein the reactive diluent is selected from the group consisting of styrene, vinyl toluene, alpha-methyl styrene and methacrylate and combinations thereof.

3. Anhydride-free curable epoxy resin composition according to claim 1, wherein the catalyst is selected from the group consisting of metal acetylacetonate, phenolic compound and combinations thereof.

4. Anhydride-free curable epoxy resin composition according to claim 1, further comprising a second anhydride-free epoxy resin.

5. Anhydride-free curable epoxy resin composition according to claim 1, wherein the anhydride-free curable epoxy composition has a viscosity at 25° C. of <200 mPa.

6. Anhydride-free curable epoxy resin composition according to claim 1, wherein the anhydride-free curable epoxy composition is precipitation-free.

7. Anhydride-free curable epoxy resin composition according to claim 1, wherein the anhydride-free curable epoxy composition, after curing, exhibits a standard deviation of Tg of at most±5.0° C.

8. Anhydride-free curable epoxy resin composite, comprising the anhydride-free curable epoxy resin composition according to claim 1 and further comprising a mica compound.

9. Anhydride-free curable epoxy resin cellulose composite, comprising the anhydride-free curable epoxy resin composition according to claim 1 and further comprising a cellulose component.

10. Insulating material comprising:
an anhydride-free curable epoxy resin composition including
a bisphenol A based epoxy resin having an epoxy content ≧5.6 equ./kg;
at least one reactive diluent:
at least one catalyst and
wherein the anhydride-free curable epoxy resin composition is cured.

11. The insulating material according to claim 10, wherein the insulating material comprises an HV insulation layer.

12. The insulating material according to claim 10, wherein the insulating material comprising an insulation layer of an Electrical machine coil.

13. Process for producing an anhydride-free curable epoxy resin composition comprising mixing together a bisphenol A based epoxy resin having an epoxy content ≧5.6 equ./kg, at least one reactive diluent, at least one catalyst, and optionally a filler.

14. Process for producing an anhydride-free curable epoxy resin composition comprising the steps of
a) providing masterbatch A comprising a first anhydride-free epoxy resin, wherein the first anhydride-free epoxy resin is a bisphenol A based epoxy resin having an epoxy content ≧5.6 equ./kg,
b) providing masterbatch B, comprising a second anhydride-free epoxy resin,
c) mixing masterbatch A with masterbatch B to obtain an anhydride-free curable epoxy resin composition.

15. Process according to claim 14,
wherein step a comprises the steps of
providing a bisphenol A based epoxy resin having an epoxy content ≧5.6 equ./kg,
mixing the bisphenol A based epoxy resin with a catalyst to obtain a mixture A,
mixing a reactive diluent and optionally a filler with mixture A to obtain masterbatch A, and
wherein step b comprises the steps of
providing a second anhydride-free epoxy resin,
mixing the second anhydride-free epoxy resin with a catalyst to obtain a mixture B,
mixing a reactive diluent and optionally a filer with mixture B to obtain masterbatch B.

16. Process according to claim 14, wherein the second anhydride-free epoxy resin is a bisphenol A based epoxy resin having an epoxy content ≧5.8 equ./kg.

17. Process according to claim 13, further comprising at least one of steps d and e:
step d bringing the reactive anhydride-free epoxy resin composition in contact with a mica compound to obtain an anhydride-free curable epoxy resin mica composite;
step e curing the anhydride-free curable epoxy resin composition of iii) or the anhydride-free curable epoxy resin mica composite of iv) to obtain an insulating material.

18. Process according to claim 14,
wherein at least one of step a or step b includes:
wherein step b comprises the steps of
providing a bisphenol A based epoxy resin having an epoxy content ≧5.6 equ./kg,
mixing the bisphenol A based epoxy resin with a catalyst to obtain a mixture A,
mixing a reactive diluent and optionally a filler with mixture A to obtain masterbatch A, and
wherein step b comprises the steps of
providing a second anhydride-free epoxy resin,
mixing the second anhydride-free epoxy resin with a catalyst to obtain a mixture B,
mixing a reactive diluent and optionally a filler with mixture B to obtain masterbatch B.

19. Anhydride-free curable epoxy resin composition according to claim 1, wherein the phenolic compound is selected from the group consisting of catechol, resorcinol, hydroquinone and pyrogallol and combinations thereof.

20. Anhydride-free curable epoxy resin composition according to claim 1, further comprising a bisphenol F based epoxy resin having an epoxy content ≧6.2 equ./kg.
